(19) United States
(12) Patent Application Publication
(10) Pub. No.: US 2010/0268604 A1
(43) Pub. Date: Oct. 21, 2010

(54) METHOD AND SYSTEM FOR PROVIDING INFORMATION BASED ON LOGO INCLUDED IN DIGITAL CONTENTS

(75) Inventors: Tae-hoon Kim, Gyeonggi-do (KR); Junhwan Kim, Seoul (KR); Jung-hee Ryu, Seoul (KR)

Correspondence Address: HUSCH BLACKWELL SANDERS LLP, 190 Carondelet Plaza, Suite 600, ST. LOUIS, MO, 63105, US

(73) Assignee: OLAWORKS, INC., Seoul (KR)

(21) Appl. No.: 12/741,827

(22) PCT Filed: Dec. 11, 2007
(86) PCT No.: PCT/KR2007/006438

§ 371 Date: May 6, 2010

(30) Foreign Application Priority Data
Nov. 28, 2007 (KR) 10-2007-0122147

(51) Int. Cl. G06Q 30/00; G06Q 10/00; G06Q 50/00; G06Q 99/00; G06F 17/30

(52) U.S. Cl. 705/14.53; 705/310; 707/780; 707/692; 707/E17.014; 707/802

(57) ABSTRACT

There are provided a method and a system for detecting a logogram from a digital content, recognizing the detected logogram, and providing a user with a variety of information associated with the logogram. In detail, the method and the system acquire a plurality of logograms associated with digital content producers, store the acquired logograms in a logogram database, compare the detected logogram with the logograms stored in the logogram database, determine whether the detected logogram matches any one of the logograms stored in the logogram database, and provide information to the user viewing the digital content or information on the content distribution to the corresponding digital content producer based on the logogram if the detected logogram matches at least one specific logogram stored in the logogram database.

### TECHNICAL FIELD

The present invention relates to a method and a system for detecting one or more logograms from a digital content, such as a moving picture and a photograph, and recognizing the detected logograms, to thereby provide a variety of information associated with the logograms. More particularly, the present invention relates to the method and the system for acquiring the logograms associated with a plurality of digital content producers, storing the acquired logograms in a logogram database, comparing a logogram detected from a digital content provided over a network with the logograms stored in the logogram database to recognize the detected logogram, and thus providing information associated with the recognized logogram to a user viewing the digital content or providing information on a content distribution to the digital content producers.

### BACKGROUND ART

With the development of network communication technologies and high-capacity storage devices, users can easily share digital contents such as a moving picture and a photograph over a network, and accordingly, there are increasing Internet service providers providing digital contents to the users or serving as an intermediary for allowing the users to share the digital contents with each other. In general, the Internet service providers may transmit digital contents retrieved by a user to the user's terminal in response to a request from the user, or provide the user with a streaming service capable of playing back the digital contents on a network in real time.

### DISCLOSURE

### Technical Problem

However, most of the digital contents distributed in such a way may be created by television broadcasting stations or other content producers. Accordingly, issues on copyright infringement are likely to be brought about between Internet service providers and the content producers. Moreover, it may be difficult for the television broadcasting stations to accurately obtain information on the audience rating of the created contents due to the copyright infringement, thereby having trouble in calculating the advertising rate etc for the created contents. Furthermore, a conventional method has drawbacks in that it provides a variety of information to the user by not considering information extracted from image(s) included in the digital contents but considering only information directly annexed to the digital contents stored in a web server. Accordingly, the conventional method could not take the preference of the user into account.

### Technical Solution

It is, therefore, an object of the present invention to provide a method and a system for detecting a logogram from a digital content, recognizing the detected logogram, acquiring information on a content producer from the recognized logogram, and providing the content producer with information on how the digital content is being distributed and providing a user with useful information associated with the digital content viewed by the user.

### ADVANTAGEOUS EFFECT

In accordance with the present invention, since information on digital content distribution may be provided to content producers, the content producers can reinforce the protection of his or her copyright.

Further, in accordance with the present invention, if digital contents distributed over a network are broadcast contents, the information on the digital content distribution can be reflected in calculating the audience rating.

Furthermore, in accordance with the present invention, after the preference of a user who views a digital content is understood by analyzing a logogram included in the digital content, the user may be provided with more suitable information based on the preference.

### DESCRIPTION OF DRAWINGS

The above objects and features of the present invention will become more apparent from the following description of the preferred embodiments given in conjunction with the accompanying drawings, in which:

FIG. 1 is a diagram illustrating data flows of providing information to content producers or users viewing digital contents by using a logogram(s) included in the digital contents in accordance with the present invention;

FIG. 2 shows a configuration of a content management system in accordance with one example embodiment of the present invention;

FIG. 3 illustrates examples of data records stored in a logogram database in accordance with one example embodiment of the present invention;

FIG. 4 illustrates examples of the logogram in accordance with one example embodiment of the present invention; and

FIG. 5 is a flowchart illustrating a process of detecting and recognizing a logogram(s) included in a digital content to thereby record the recognized logogram in accordance with one example embodiment of the present invention.

### BEST MODE

The configurations of the present invention for accomplishing the above objects of the present invention are as follows.

In one aspect of the present invention, there is provided a method for providing information on at least one logogram included in at least one digital content, the method comprising the steps of: (a) detecting an image of the logogram from the digital content; (b) comparing the detected logogram with a plurality of logograms included in a logogram database to measure a similarity therebetween, the logogram database storing the logograms and information on content producers associated with the logograms; (c) acquiring information on a specific content producer associated with a specific logogram included in the logogram database if the similarity between the detected logogram and the specific logogram is same as or large than a predetermined reference value; and (d) providing the digital content with at least part of the information on the specific content producer or at least part of identification information capable of distinguishing the specific content producer as attribute information of the digital content.

In another aspect of the present invention, there is provided a system for providing information on at least one logogram included in at least one digital content, the system comprising: a logogram database for storing a plurality of logograms and information on content producers associated with the logograms; a logogram detection unit for detecting an image of the logogram from the digital content by analyzing at least one frame included in the digital content; a logogram extraction unit for extracting the detected logogram from the frame; a logogram matching unit for comparing the extracted logogram with the logograms stored in the logogram database and measuring a similarity therebetween; and a tagging unit, if the similarity between the extracted logogram and a specific logogram stored in the logogram database is same as or large than a predetermined reference value, for providing the digital content with at least part of information on a specific content producer who created the specific logogram or at least part of identification information capable of distinguishing the specific content producer as attribute information of the digital contents.

### MODE FOR INVENTION

In the following detailed description, reference is made to the accompanying drawings that show, by way of illustration, specific embodiments in which the present invention may be practiced. These embodiments are described in sufficient detail to enable those skilled in the art to practice the present invention. It is to be understood that the various embodiments of the present invention, although different from one another, are not necessarily mutually exclusive. For example, a particular feature, structure, or characteristic described herein in connection with one embodiment may be implemented within other embodiments without departing from the spirit and scope of the present invention. In addition, it is to be understood that the location or arrangement of individual elements within each disclosed embodiment may be modified without departing from the spirit and scope of the present invention. The following detailed description is, therefore, not to be taken in a limiting sense, and the scope of the present invention is defined only by the appended claims, appropriately interpreted, along with the full range of equivalents to which the claims are entitled.

Data Flow

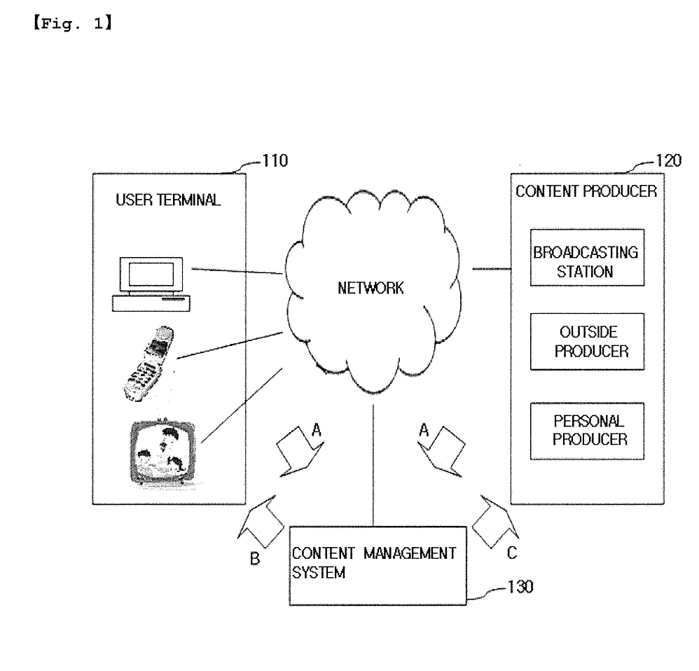

FIG. 1 is a diagram illustrating data flows of providing information to content producers or users viewing digital contents by using a logogram(s) included in the digital contents in accordance with the present invention.

Referring to a data flow A shown in FIG. 1, content producers 120, such as a broadcasting station, an outside producer, a personal producer and the like, may produce a plurality of digital contents and register the produced digital contents in a content management system 130.

The digital contents may be directly registered in such a manner that the content producer 120 accesses the content management system 130 to upload the digital contents thereto. In another case, the digital contents may be also registered in such a manner that a user accesses a server of the content producers 120 via a user terminal 110, such as a computer or any other similar electronic device, to acquire the digital contents therefrom, and then transmits the acquired digital contents to the content management system 130. In still another case, the content management system 130 may function as a peer-to-peer (P2P) server by providing only a link capable of acquiring the digital contents.

Referring to a data flow B shown in FIG. 1, the content management system 130 may provide the digital contents to the user terminal 110, along with various services based on information on a logogram(s) included in the digital contents, such as a tailored advertisement service and a recommend service for recommending other contents related to the logogram.

Referring to a data flow C shown in FIG. 1, the content management system 130 may provide the content producers 120 with a statistical report on how the digital contents produced by the content producers 120 are being distributed to the users (hereinafter, referred to as a content distribution status report) or a copyright infringement report on whether the copyright of the content producers 120 is infringed.

The content management system 130 may be an external entity connected to the user terminal 110 via a network as shown in FIG. 1, but in other case it may be included in the user terminal 110.

Content Management System

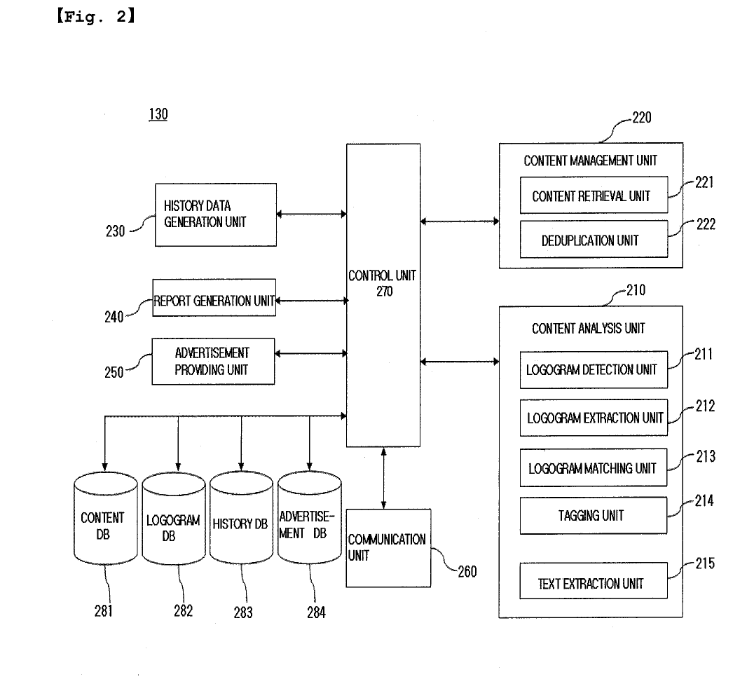

FIG. 2 is a configuration of the content management system 130 in accordance with one example embodiment of the present invention.

In detail, the content management system 130 may include a content analysis unit 210, a content management unit 220, a history data generation unit 230, a report generation unit 240, an advertisement providing unit 250, a communication unit 260, a control unit 270, and databases 281 to 284.

The content analysis unit 210 may include a logogram detection unit 211, a logogram extraction unit 212, a logogram matching unit 213, a tagging unit 214, and a text extraction unit 215.

Specifically, the logogram detection unit 211 analyzes a digital content stored in the content database 281 to detect whether a logogram is included in the digital content.

If the logogram is detected, the logogram extraction unit 212 extracts an area including the logogram (hereinafter, referred to as a logogram area) from the digital content.

The logogram matching unit 213 performs an image matching process between a logogram included in the extracted logogram area and a plurality of logograms stored in the logogram database 282 to determine whether there is at least one specific logogram in the logogram database 282 which matches the logogram included in the extracted logogram area.

If there is the specific logogram in the logogram database 282, the tagging unit 214 may provide information on the specific logogram to the digital content as an attribute of the digital content.

Meanwhile, if character strings such as a caption etc. are included in the digital content, the text extraction unit 215 can extract the character strings from the digital content. Text data determined as a primary character string among the extracted character strings may be provided to the digital content as an attribute of the digital content by the tagging unit 214.

The content management unit 220 may include a retrieval unit 221 and a deduplication unit 222.

Specifically, the retrieval unit 221 retrieves, from the content database 281, digital contents meeting a query received from the user terminal 110, creates a list including the retrieved digital contents, and transmits the list to the user terminal 110.

The deduplication unit 222 removes redundant digital contents from the list generated by the retrieval unit 221, by referring to attributes of the digital contents registered in the content database 281. In addition, the deduplication unit 222 may periodically or aperiodically check whether there is redundant digital content(s) in the content database 281, regardless of a request from the user terminal 110, to thereby rearrange servers on a content delivery network (CDN) or remove the redundant digital contents from the content database 281. Accordingly, a high efficient content database 281 may be realized.

The history data generation unit 230 generates, per user or digital content, history data on how the digital content has been used, and stores the history data in the history database 283.

The report generation unit 240 generates a content distribution status report and/or a copyright infringement report to be provided to the digital content producers 120, by referring to the history data stored in the history database 283.

The advertisement providing unit 250 provides, to the user, information on other digital contents associated with the digital content provided to the user or a tailored advertisement suitable for the user, by referring to the information stored in the history database 283 and the content database 281. To this end, the content management system 130 may include an advertisement database 284 storing the advertisement information associated with the digital content provided to the user.

The communication unit 260 enables the content management system 130 to communicate with external systems, such as the user terminal 110, the server of the content producer 120 and the like.

The control unit 270 controls the data flows among the content analysis unit 210, the content management unit 220, the history data generation unit 230, the report generation unit 240, the advertisement providing unit 250, the communication unit 260, and the databases 281 to 284.

Finally, each of the databases in accordance with the present invention refers to a database having data records stored therein based on a file system in a broad sense as well as a database in a narrow sense. Moreover, the databases may include a set of logs if the logs can be retrieved and data can be extracted from the retrieved logs.

In accordance with another example embodiment of the present invention, all or some of the components in the content management system 130 may be included in the user terminal 110. In this case, the user terminal 110 and the content management system 130 may be arranged in a different manner. For example, some components such as the content management unit 220, the content database 281 and so forth may be replaced with a retrieval function, a file system and the like provided by an operating system installed in the user terminal 110.

Building Logogram Database

The logogram database 282 includes information on logograms associated with the content producers 120.

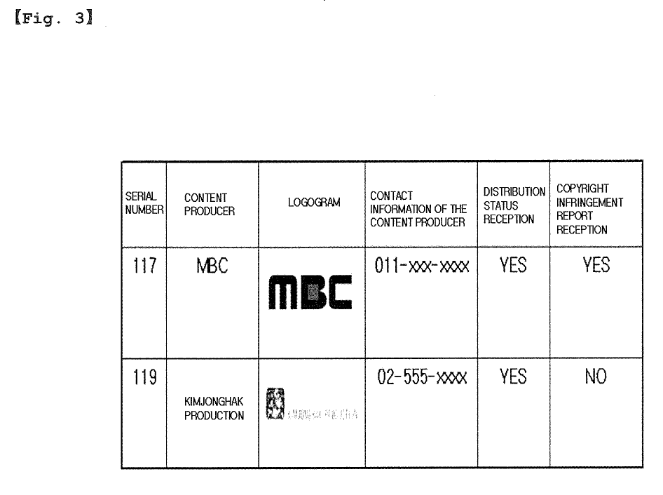

FIG. 3 illustrates examples of data records stored in the logogram database 282 in accordance with one example embodiment of the present invention. Referring to FIG. 3, the logogram database 282 may include fields of a serial number, a content producer, a logogram, contact information of the content producer, distribution status reception, and copyright infringement report reception.

The “serial number” field may include identification information for identifying each of the data records stored in the logogram database 282.

The “content producer” field includes identification information on each of the content producers who produce digital contents in which one or more logograms are inserted. Each of the content producers may be represented by a name, an ID, and the like.

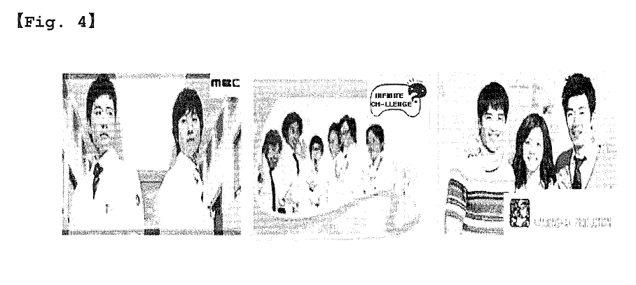

The “logogram” field may include information on the logograms included in the digital contents produced by the content producers. In accordance with one example embodiment of the present invention, the “logogram” field may include image data of the logograms or information on paths capable of acquiring the image data of the logograms. FIG. 4 illustrates examples of logograms included in the digital contents in accordance with one example embodiment of the present invention. As shown in FIG. 4, the “logogram” field may include a logogram standing for a broadcasting station such as ‘MBC’(Korea), ‘BBC’(UK), CNN (USA), and the like, a logogram standing for a program producer such as ‘KIMJONGHAK PRODUCTION’(Korea), ‘New Line Cinema’(USA), and so forth, and a logogram standing for a broadcast program such as ‘Infinite Challenge’(Korea), ‘Late Show’(USA), ‘Oprah Winfrey Show’(USA), and the like. The “logogram” field is not limited thereto, but it may also include a logogram standing for another entity, such as a personal producer.

The “contact information of the content producer” field includes, e.g., an e-mail, a telephone number, a home address and the like of the content producer.

The “information on distribution status” field indicates whether a content distribution status report is to be received.

The “information on the copyright infringement report” field indicates whether a copyright infringement report is to be received if the digital content produced by the content producer is distributed without permission of the content producer.

Information may be directly recorded in the logogram database 282 in case the content producer 120 accesses the content management system 130, or it may be indirectly recorded in the logogram database 282 by an operator (i.e., manager) of the content management system 130. If the logogram database 282 is included in the user terminal 110, the information to be stored in the logogram database 282 may be acquired from the content management system 130 or other remote systems over the network.

Digital Content Analysis

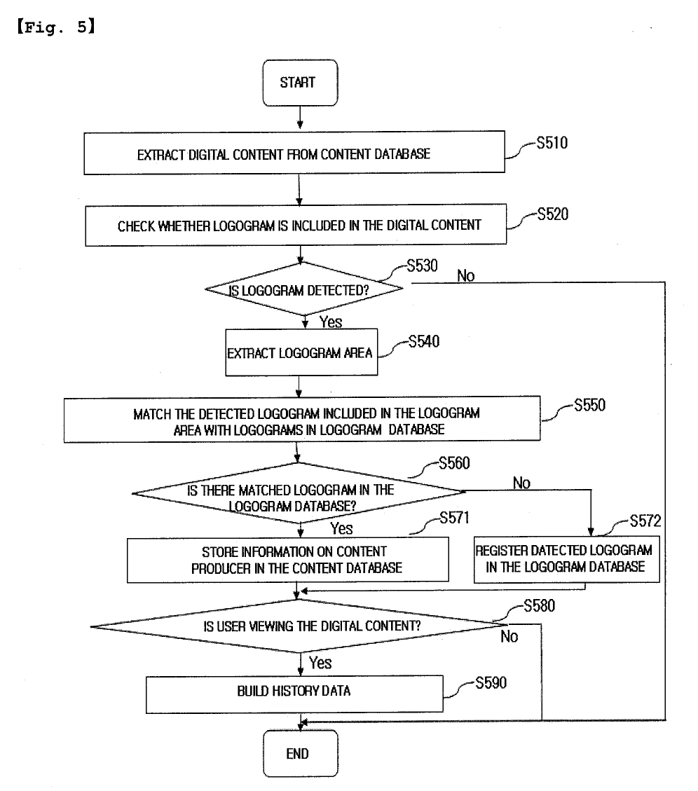

FIG. 5 is a flowchart illustrating a process of detecting and recognizing a logogram included in digital contents to thereby record the recognized logogram in accordance with one example embodiment of the present invention.

Referring to FIG. 5, the content analysis unit 210 acquires information on a logogram included in a digital content (S510). The information on the logogram may be acquired before or after the digital content is stored in the content database 281. Alternatively, if the content database 281 and the content analysis unit 210 are included in the user terminal 110, the information on the logogram may be acquired while the user is viewing the digital content.

The logogram detection unit 211 analyzes frames of the digital content to check whether the information on the logogram is included therein (S520). If it is determined that the information on the logogram is included in the frames (S530), the logogram extraction unit 212 extracts a logogram area from the frames (S540).

The logogram may be detected and extracted from the digital content by using at least one of techniques well known to those who skilled in the art: Jinqiao Wang, et al., “A Robust Method for TV Logo Tracking in Video Streams”, 2006 IEEE International Conference; “Automatic TV Logo Detection, Tracking and Removal in Broadcast Video”, LECTURE NOTES IN COMPUTER SCIENCE, Vol. 4352, 2007; and “Automatic Video Logo Detection and Removal”, MULTIMEDIA SYSTEMS Journal, Vol. 10(5), August 2005. According to these documents, frames of a digital content are analyzed to determine whether there is a logogram in the digital content; and if there is a logogram in a specific frame, the specific frame is considered to include advertisement information, and thus, video recording is stopped or the logogram included in a corresponding area is removed. Herein, the above-mentioned documents are incorporated in this specification by reference. Further, it is to be noted that the present invention should not be construed as being limited to the aforementioned techniques.

After the logogram area is extracted from the digital content using the aforementioned techniques, the logogram matching unit 213 checks whether a logogram same as or similar to a logogram included in the extracted logogram area exists or not in the logogram database 282 (S550). In this case, a similarity between the logogram included in the extracted logogram area and the logograms included in the logogram database 282 may be determined by at least one of techniques well known to those who skilled in the art: Clark F. Olson, “Maximum-Likelihood Image Matching”, IEEE TRANSACTIONS ON PATTERN ANALYSIS AND MATCHING INTELLIGENCE, Vol. 24(6), June 2002; and Lei Wang, et al., “Video Local Pattern Based Image Matching for Visual Mapping”, the 18th International Conference on Pattern Recognition, Vol. 3. Herein, the above-mentioned documents are incorporated in this specification by reference. Further, it is to be noted that the present invention should not be construed as being limited to the aforementioned techniques.

If the logogram matching unit 213 determines that the logogram included in the extracted logogram area is same as or similar to the specific logogram included in the logogram database 282, the tagging unit 214 may record information on the specific logogram, e.g., the content producer etc. associated with the specific logogram in the content database 281, as an attribute of the digital content (S571). If the logogram matching unit 213 determines that the logogram included in the extracted logogram area differs from all the logograms included in the logogram database 282, the extracted logogram may be recorded as a new logogram in the logogram database 282 (S572).

In accordance with one example embodiment of the present invention, one or more primary character strings may be acquired from the digital content using an optical character recognition (OCR) technique, to thereby record the acquired primary character strings as an attribute of the digital content. Herein, the process of acquiring the logogram from the digital content and the process of acquiring primary character strings from the digital content may be performed in a separate way or at the same time.

For example, if the digital content is one of programs in series, it is common to display, at a starting portion of the digital content, information on a subtitle or a serial number of the program as a caption and the like. Herein, the information may be considered as a primary character string representing an attribute of the digital content, and thus, the tagging unit 214 may store the information on the subtitle or the serial number in the content database 281. The information may be used as a query or used for removing redundant digital contents from the list including the retrieved digital contents meeting the query.

The text data may be extracted from the digital contents by using techniques well known to those who skilled in the art: Jian Liang, et al., “Camera-based Analysis of Text and Documents: a survey”, INTERNATIONAL JOURNAL ON DOCUMENT ANALYSIS AND RECOGNITION, 2005; and Jung Gi-Chol, et al., “Text Information Extraction in Images and Video: a survey”, PATTERN RECOGNITION, 2004. Herein, the above-mentioned documents are incorporated in this specification by reference. Further, it is to be noted that the present invention should not be construed as being limited to the aforementioned techniques.

As described above, the process for acquiring the information on the logogram from the digital content may be performed while the user is viewing the digital contents (S580). In this case, the history data generation unit 230 stores, in the history database 283, information on the utilization of the digital content by the user (S590). Herein, since the step S590 may be distinct from the steps S530-S550, the step S590 may be performed at any time. The generation of the history data and the use thereof will now be described in more detail.

Using History Data and Providing Advertisement

If the user accesses the content management system 130 to use the digital content, the history data generation unit 230 stores, in the history database 283, so called history data including the information on the utilization of the digital content by the user.

The history data may include information on the status of the utilization of the digital content. For example, if the users play back the digital content on a network or store the same in the user terminal 110, the history data generation unit 230 may store, in the history database 283, information on the number of times the digital content was utilized and the time when the digital content was utilized, the users who utilized the digital content, and the like.

Moreover, the history data may include status information of each user. For example, if the users play back the digital content on the network or store the same in the user terminal 110, the history data generation unit 230 may store, in the history database 283, information on the number of times the digital content was utilized by each user and the time when the digital content was utilized by each user, each of the users who utilized the digital content, and the like.

The history database 283 built as described above may be used in various ways.

In accordance with one example embodiment of the present invention, the report generation unit 240 may create a content distribution status report on the basis of the history data stored in the history database 283 and the information on the content producer presented as tag information to the digital content by the tagging unit, and then provide the created content distribution status report to the content producer. The content distribution status report may include statistical data, such as the number of times the digital content was retrieved, the number of times the digital content was transmitted to users, information on the users who utilized the digital content, information on a server(s) or a system(s) providing the digital content, and the like. If the content producer 120 is a broadcasting station, the content distribution status report may be utilized for adding up the audience rating of the digital content (e.g., group statistics, individual statistics, and demographic statistics). If the digital content is illegally-distributed one, the content distribution status report may be utilized as a copyright infringement report.

In accordance with another example embodiment of the present invention, the advertisement providing unit 250 may provide a tailored advertisement to a user based on the history data of the user recorded in the history database 283. That is, the advertisement providing unit 250 may recommend for the user other digital contents or information on goods, by referring to the history data of the user (i.e., by recognizing the user's preference). For example, the advertisement providing unit 250 may create a list by associating a table of digital contents having been used by the user stored in the history database 283 with information on the producers who create each of the digital contents stored in the logogram database 282. If a specific content producer frequently appears on the list, the advertisement providing unit 250 may determine that the user shows interest in the digital contents produced by the specific content producer and recommend to the user other programs created by the specific content producer or goods related to the digital contents.

In accordance with still another example embodiment of the present invention, the advertisement providing unit 250 may provide the advertisement to the user by referring to the attribute of the digital contents stored in the content database 281. The attribute of the digital contents may be acquired by analyzing the digital contents through the tagging unit 214, as described above. In other case, a tag(s) attached to the digital contents by a manager of the content management system 130 or users may be considered to be the attribute of the digital contents. For example, if digital content viewed by the user is a specific one of programs in series, the advertisement providing unit 250 may recommend to the user a next series or goods associated with persons appearing in the specific one. The advertisement information may be provided at a suitable time before or after the digital content is played back, or it may be provided in a form of a text such as a caption appearing on a screen of a content player or outside of the content player.

Since the revenue of the advertisement counted as mentioned above may be distributed to the content producers 120 such as a broadcasting station, an outside producer, a personal producer, and the like, a great contribution may be made toward the activation of the distribution of the digital contents over the network.

The embodiments of the present invention can be implemented in a form of executable program command through a variety of computer means recordable to computer readable media. The computer readable media may include solely or in combination, program commands, data files and data structures. The program commands recorded to the media may be components specially designed for the present invention or may be usable to a skilled person in a field of computer software. Computer readable record media include magnetic media such as hard disk, floppy disk, magnetic tape, optical media such as CD-ROM and DVD, magneto-optical media such as floptical disk and hardware devices such as ROM, RAM and flash memory specially designed to store and carry out programs. Program commands include not only a machine language code made by a complier but also a high level code that can be used by an interpreter etc., which is executed by a computer. The aforementioned hardware device can work as more than a software module to perform the action of the present invention and they can do the same in the opposite case.

While the invention has been shown and described with respect to the preferred embodiments, it will be understood by those skilled in the art that various changes and modification may be made without departing from the spirit and scope of the invention as defined in the following claims.

Accordingly, the thought of the present invention must not be confined to the explained embodiments, and the following patent claims as well as everything including variations equal or equivalent to the patent claims pertain to the category of the thought of the present invention.

1. A method for providing information on at least one logogram included in at least one digital content, the method comprising the steps of:
(a) detecting an image of a logogram from a digital content, the logogram being a symbol, word(s), any other graphical image, or combination thereof that represents an identity of a producer, content distributor or broadcasting network of the digital content;
(b) comparing the detected logogram with a plurality of logograms stored in a logogram database to determine a match therebetween, the logogram database storing the logograms and profile information of the content producer, content distributor or broadcasting network associated with the plurality of logograms;
(c) extracting information on a content producer, content distributor or broadcasting network associated with a logogram stored in the logogram database if similarity between the detected logogram and the logogram stored in the logogram database exceeds a predetermined reference value; and
(d) associating at least a portion of the extracted information on the content producer, content distributor or broadcasting network, with the digital content as attribute information of the digital content.

2. The method of claim 1, further comprising the step of:
(e) upon detecting usage of the digital content, storing, in a history database, information on the digital content including the attribute information, a number of usage counts of the digital content and a time when the digital content was utilized.

3. The method of claim 2, further comprising the step of:
(f) analyzing at least one of the information stored in the history database and the attribute information to thereby create analysis information, and then transmitting the analysis information to a terminal or a system of the content producer, content distributor or broadcasting network.

4. The method of claim 3, wherein the analysis information includes information on copyright infringement status indicating whether the digital content has been utilized without a permission of the content producer, content distributor or broadcasting network.

5. (canceled)

6. The method of claim 2, wherein the step (d) includes the step of extracting text data from the digital content; and
then providing at least part of the extracted text data to the digital content as the attribute information.

7. The method of claim 6, wherein the text data is acquired by applying an optical character recognition (OCR) technique to the digital content.

8. The method of claim 7, wherein the attribute information is used to provide an advertisement to the user.

9. (canceled)

10. The method of claim 8, wherein, at the step (e), a retrieval result in which a possibility that the redundancy of the digital content is to be retrieved is reduced by using the text data is provided to the user, if the user inputs a query to retrieve the digital content.

11. The method of claim 6, wherein the attribute information of the digital content or the information stored in the history database is used to provide advertisement information to the user.

12. (canceled)

13. The method of claim 11, wherein a part of revenue obtained by providing the advertisement information is distributed to the content producer.

14. A system for providing information on at least one logogram included in at least one digital content, the system comprising:
a logogram database for storing a plurality of logograms and information on content producers, content distributors or broadcasting networks associated with the logograms, the logogram being a symbol, word(s), any other graphical image, or combination thereof that represent an identity of a producer, content distributor or broadcasting network of the digital content;
a logogram detection unit configured for detecting an image of a logogram from a digital content by analyzing at least one frame included in the digital content;
a logogram matching unit configured for comparing the detected logogram with the logograms stored in the logogram database and for determining a match therebetween; and
a tagging unit configured, if similarity between the detected logogram and a logogram stored in the logogram database exceeds a predetermined reference value, for associating the digital content with at least a portion of information on a content producer, content distributor or broadcasting network of the digital content as attribute information of the digital content.

15. The system of claim 14, further comprising:
a history-data generation unit for generating history data which include information on the utilization of the digital content by the user.

16. The system of claim 15, wherein the history data includes at least one of information on the digital content, at least one user who utilized the digital content, a number of times the digital content was utilized and the time when the digital content was utilized.

17. The system of claim 16, further comprising: a history database for storing the history data.

18. The system of claim 17, further comprising: a report generation unit for generating a report to be provided to the specific content producer or the user by analyzing at least one of the history data and the attribute information.

19. The system of claim 18, wherein the report includes either information on copyright infringement status indicating whether the digital content produced by the specific content producer has been utilized without a permission of the specific content producer or statistical information indicating how the digital content is being utilized.

20. (canceled)

21. The system of claim 14, further comprising: a text extraction unit for extracting text data from the digital content.

22. The system of claim 21, wherein the tagging unit provides the digital content with at least part of the extracted text data as the attribute information.

23. (canceled)

24. The system of claim 15, further comprising:
an advertisement providing unit for providing advertisement information to the user by using the attribute information or the information stored in the history database.

25. (canceled)

26. The system of claim 24, wherein a part of revenue obtained by providing the advertisement information is distributed to the content producer.

27. The system of claim 14, further comprising:
a content management unit including: a content retrieval unit for retrieving the digital content by using the attribute information; and
a deduplication unit for reducing a possibility that the redundancy of the digital content is to be retrieved by using the attribute information.

28. One or more computer-readable media having stored thereon a computer program that, when executed by one or more processors, causes the one or more processors to perform acts including:
detecting an image of a logogram from a digital content, the logogram being a symbol, word(s), any other graphical image, or combination thereof that represents an identity of a producer, content distributor or broadcasting network of the digital content;
comparing the detected logogram with a plurality of logograms stored in a logogram database to determine a match therebetween, the logogram database storing the logograms and profile information of the content producer, content distributor or broadcasting network associated with the plurality of logograms;
extracting information on a content producer, content distributor or broadcasting network associated with a logogram stored in the logogram database if similarity between the detected logogram and the logogram stored in the logogram database exceeds a predetermined reference value; and
associating at least a portion of the extracted information on the content producer, content distributor or broadcasting network, with the digital content as attribute information.
